(19) United States
(12) Patent Application Publication
(10) Pub. No.: US 2014/0084075 A1
(43) Pub. Date: Mar. 27, 2014

(54) NOZZLE FLUID FLOW INDICATOR SYSTEM

(71) Applicant: AKRON BRASS COMPANY, WOOSTER, OH (US)

(72) Inventors: NELSIMAR VANDELLI, WOOSTER, OH (US); JERRY CHRISTENSEN, WOOSTER, OH (US); KEVIN J. PETIT, WOOSTER, OH (US); MICHAEL HART, WOOSTER, OH (US); JEREMIAH FRIEND, WOOSTER, OH (US)

(73) Assignee: AKRON BRASS COMPANY, WOOSTER, OH (US)

(21) Appl. No.: 14/032,837

(22) Filed: Sep. 20, 2013

Related U.S. Application Data
(60) Provisional application No. 61/703,885, filed on Sep. 21, 2012.
(60) Provisional application No. 61/814,627, filed on Apr. 22, 2013.

(51) Int. Cl. B05B 12/00; G01F 1/34

(52) U.S. Cl. CPC B05B 12/008; G01F 1/34
USPC 239/1; 239/74

(57) ABSTRACT

A fluid flow indicator system for fluid-dispensing nozzles including a fluid passage, a sensor in communication with the fluid passage, a control in electrical communication with the sensor, a power source in electrical communication with the sensor and the control, and at least one indicator in electrical communication with the control and actuable under at least one predetermined fluid condition. The sensor measures a fluid condition in the inlet of the fluid passage and generates a corresponding output signal. The control processes the output signal from the sensor, compares the output signal with predetermined fluid condition threshold ranges, each predetermined fluid condition threshold range representing a corresponding level of fluid condition, determines the corresponding level of fluid condition, and actuates the indicator corresponding to the predetermined fluid condition to allow a user of the fluid-dispensing nozzle to perceive an indication of the level of fluid condition.

### CROSS-REFERENCE TO RELATED APPLICATIONS

This application claims priority to U.S. provisional application 61/703,885, filed Sep. 21, 2012, and U.S. provisional application 61/814,627, filed Apr. 22, 2013, the entire contents of each application being incorporated by reference.

### FIELD

The present invention relates generally to fluid-dispensing nozzles utilized in connection with fire-fighting equipment, in particular to a fluid flow indicator system for fluid-dispensing nozzles.

### BACKGROUND

Conventionally, a nozzle is connected to an end portion of a fire hose and is used to direct pressurized fluids discharged from the hose (“hand-line”). A nozzle can also be connected to a monitor to deliver higher flow rate capacity fluid streams. The nozzle is sometimes provided with an on/off mechanism for selectably controlling the discharge of fluids from the nozzle. Some nozzles also provide means for varying the flow rate of the fluids and/or the pattern in which fluids are discharged.

Hand-line and monitor nozzles represent important pieces of equipment utilized in fire fighting. They are particularly useful because they can be operated at an extended distance from the fire site or, conversely, in relatively close proximity to the fire. Depending upon how they are configured, hand-line and monitor nozzles can operate at a single flow rate, at manually adjustable flow rates (i.e., “multi-flow”), or automatically adjusted flow rates, as well as in straight-stream, partial fog and full fog spray pattern conditions. An automatically adjusted flow rate nozzle is designed to maintain a relatively constant pressure over a range of flow rates.

Most nozzles are designed to function optimally at pre-determined flow rates, depending upon their intended purpose. During operation of a conventional hand-line or monitor nozzle, there is no direct indication of the actual pressure and flow at the nozzle inlet of the fluids being dispensed. Consequently, the user, through training, typically learns to rely on the reaction force exerted by the nozzle—which is a function of flow and pressure—to determine if the rated pressure and flow are being achieved properly. Although practical, this approach is quantitatively inaccurate. As a result, some operators, especially less experienced ones, are not likely to be able to differentiate between optimal, non-optimal, and lower life-threatening flow conditions.

Accordingly, it is important to the effectiveness of single flow, multi-flow and automatic nozzles to be able to provide the nozzle operator with some type of indication that is representative of the actual flow as compared to the rated design flow. Ideally, the flow indication should be easily accessible to and viewable by the operator and is preferably located at or near the nozzle as opposed to being remotely located “upstream” from the nozzle where access may be difficult or even impossible.

For a hand-line or monitor nozzle the fluid flow rate is a function of the fluid pressure, and the nozzles are typically designed to provide a given flow rate based on available fluid pressure. Existing systems are not designed to measure the actual fluid flow at the nozzle inlet, or to provide a comparison of the measured flow to the rated performance for a given nozzle. Nor are existing systems designed to provide an adjustable indication to the operator as an integral element of the nozzle. Known flow indicating systems installed further upstream of the nozzle also cannot provide the nozzle operator with a quick and accurate flow indication that will enable the user to optimize nozzle performance. Thus, operators do not have the advantage of accurate flow information to assist in life-threatening situations during a fire fighting event. There remains a need for a fluid flow indicating system for use with hand-line or monitor single flow, multi-flow and automatic nozzles that overcomes these drawbacks.

### SUMMARY

A nozzle fluid flow indicator system is disclosed according to the present invention. The system overcomes the drawbacks described above in that it is manufactured as part of the nozzle or integrated directly onto the nozzle and capable of measuring the actual flow at the nozzle inlet.

The disclosed invention is a fluid flow indicator system that provides the nozzle operator with a perceivable indication under predetermined fluid flow conditions. By determining the nozzle flow, the nozzle operator can determine if the actual flow is the desired rated flow, a non-optimal flow or a dangerously low flow that could create life threatening conditions.

In one embodiment the disclosed invention includes a relatively compact and programmable fluid flow indicator that may be integrated with fluid-dispensing nozzles, allowing for easy reading and interpretation of predetermined fluid flow conditions without adversely affecting or compromising nozzle handling, operation and performance. A fluid flow indicator system for fluid-dispensing nozzles includes a fluid passage, a sensor in communication with the fluid passage, a control in electrical communication with the sensor, a power source in electrical communication with the sensor and the control, and at least one indicator in electrical communication with the control and actuable under at least one predetermined fluid condition. The sensor measures a fluid condition in the inlet of the fluid passage and generates an output signal corresponding to the measured fluid condition. The control processes the output signal from the sensor, compares the output signal with predetermined fluid condition threshold ranges, each predetermined fluid condition threshold range representing a corresponding level of fluid condition, determines the corresponding level of fluid condition, and actuates the indicator corresponding to the predetermined fluid condition to allow a user of the fluid-dispensing nozzle to perceive an indication of the level of fluid condition.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 depicts a nozzle shut-off body having a covered fluid flow indicator system assembled thereto according to an embodiment of the present invention;

FIG. 2 depicts the fluid flow indicator system of FIG. 1 with the cover removed and without the shut-off body;

FIG. 3 depicts a cut-away view of the flow indicator system of FIG. 2 at the outlet end of the nozzle shut-off body;

FIG. 4 depicts an exploded view of the flow indicator system of FIG. 1;

FIG. 5 depicts a further exploded view with details of the nozzle inlet adaptor of the fluid flow indicator system of FIG. 1, and of a coupling on the inlet thereof;

FIG. 6 depicts the nozzle shut-off body with a fluid flow indicator system of FIG. 1 assembled with additional components to form a nozzle assembly;

FIG. 7 depicts a partial sectional view 7-7 of the nozzle assembly of FIG. 6 with the discharge, valve, handle and handgrip shown schematically; and

FIG. 8 depicts a schematic block diagram of the components of the fluid flow indicator system control.

### DETAILED DESCRIPTION

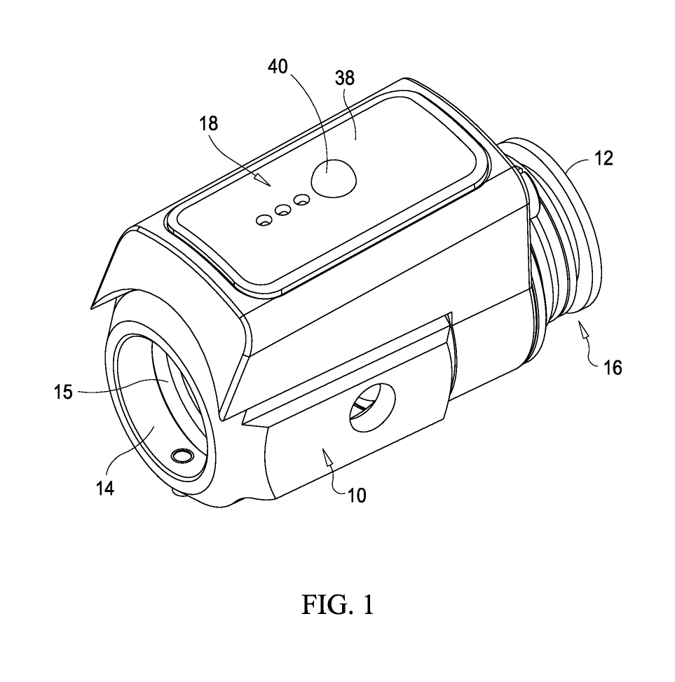

The general arrangement of a nozzle shut-off body 10 is shown in FIG. 1 according to an embodiment of the present invention. Shut-off body 10 includes a nozzle inlet 12, a nozzle outlet 14, a fluid passage 15 configured to conduct fluid flow from the nozzle inlet to the nozzle outlet, and a nozzle inlet adapter 16.

Nozzle shut-off body 10 further includes a fluid flow indicator system 18 assembled, attached or coupled thereto, resulting in an integrated flow indicator system that is usable to indicate any desirable operating flow condition. Fluid flow indicator system 18 is preferably rugged, relatively compact and has indicator settings for controlling indicators (as detailed further below) that are field programmable by the user. Alternatively, the indicator settings may be pre-programmed and/or fixed.

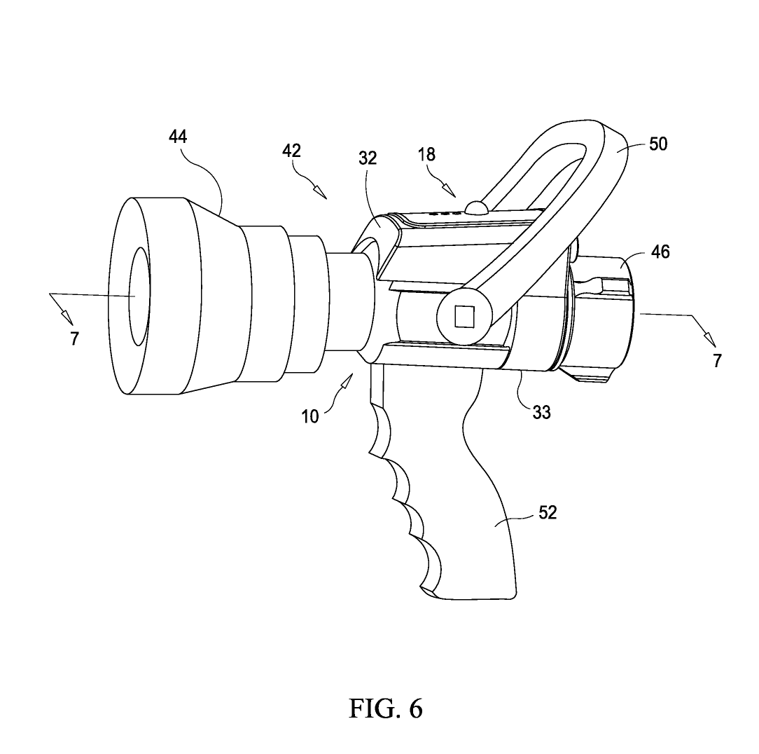

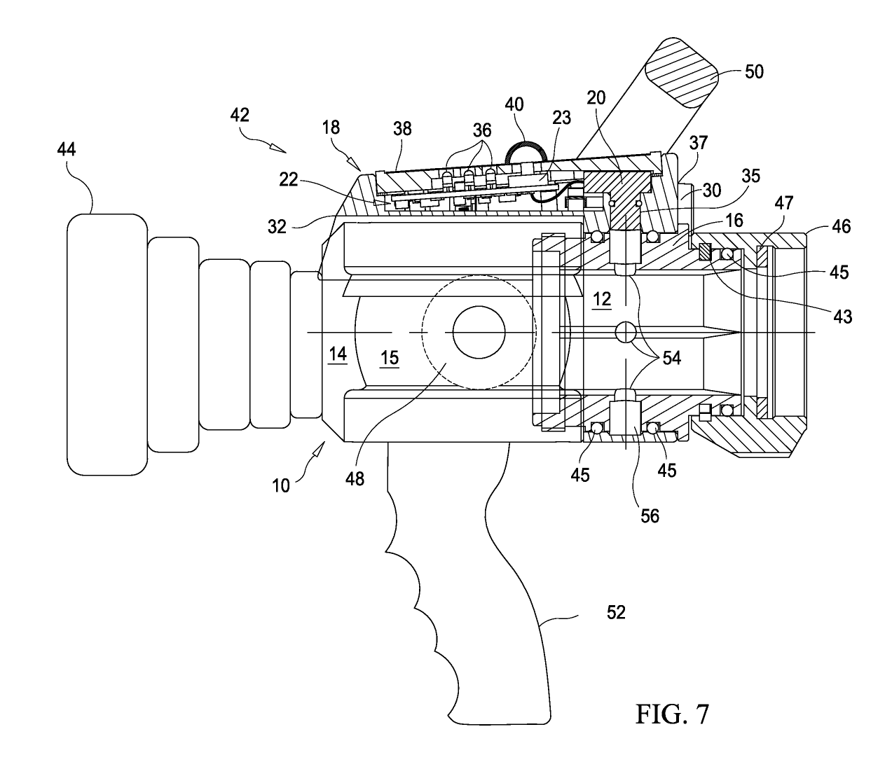

Nozzle inlet adapter 16 is preferably configured to secure fluid flow indicator system 18 to shut-off body 10, resulting in a fluid flow indicator system that is assembled to shut-off body 10, which is in turn assembled with other components to form a complete nozzle assembly 42 as described in detail further below. In one embodiment, shut-off body 10 can be retrofitted with existing nozzles. Alternatively, fluid flow indicator system 18 may be made integral with, and manufactured concurrently with, shut-off body 10. Additionally, fluid flow indicator system 18 may be manufactured or integrated directly onto any external and internal components that constitute the nozzle (see nozzle assembly 42 shown in FIGS. 6 and 7).

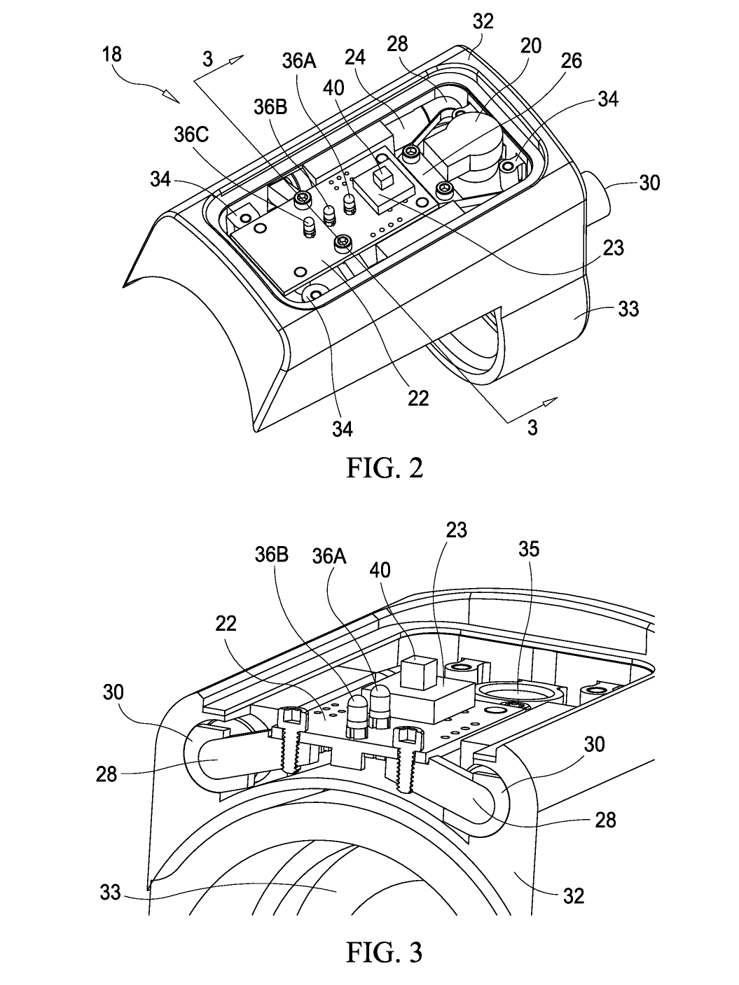

Further details of fluid flow indicator system 18 are shown in FIGS. 2-5 according to an embodiment of the present invention. In one embodiment, fluid flow indicator system 18 includes a pressure transducer sensor or measuring device 20 (hereafter generally “sensor 20”) that is configured to measure the operating fluid condition of pressure or flow rate at nozzle inlet 12 and to produce a proportional electrical output signal 21. Any suitable pressure transducer sensor or measuring device may be used to determine the operating fluid condition of pressure or flow rate in the nozzle inlet 12 of fluid passage 15. Example sensors 20 include, without limitation, orifice, wedge, venturi tube, flow nozzle, pitot tube, elbow meter, target meter, variable area, positive displacement, turbine, vortex, electromagnetic, ultrasonic (Doppler), ultrasonic (time-of-travel), mass (Coriolis), weir (V-notch) or fume (Parshall).

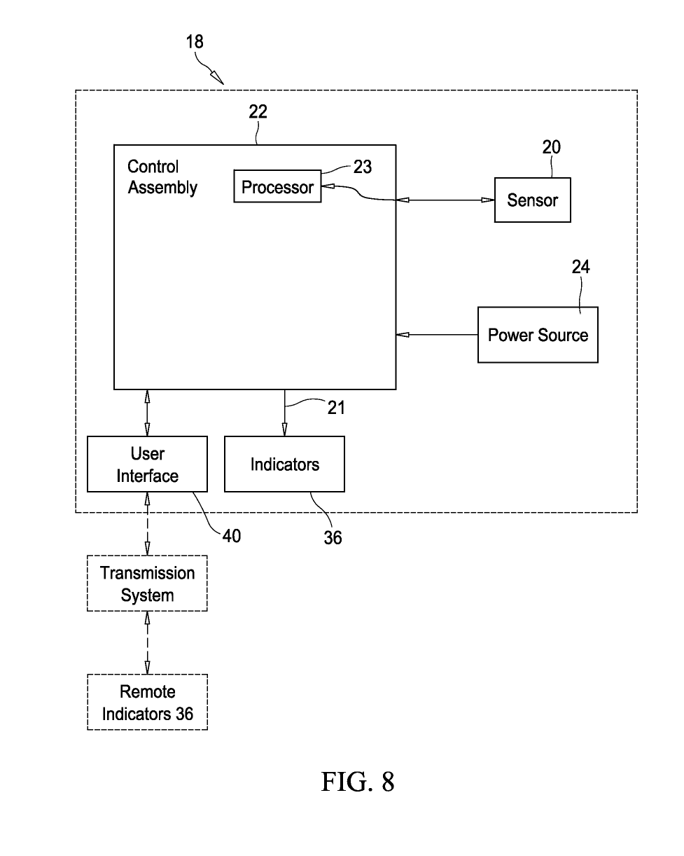

In one embodiment, fluid flow indicator system 18 includes a control assembly 22, which may include a printed circuit board. Control assembly 22 is configured for unidirectional or bidirectional electrical communication with pressure sensor 20 (shown schematically in FIG. 8). Control assembly 22 processes the electrical output signal 21 generated by sensor 20 and compares the output signal 21 with predetermined, or determinable programmed fluid condition threshold ranges (in a processor detailed further below) to derive the corresponding level of fluid condition. The levels of fluid condition may correspond to two or more fluid condition threshold ranges, such as ranges of pressure or flow rate. The levels of fluid condition preferably include four ranges that rank from extremely low flow, low flow, medium flow, to nominal flow. Control assembly 22 transmits an output signal 21 that actuates an indicator (as detailed below) to signal to the user of the fluid-dispensing nozzle the real-time operating fluid flow condition as compared to the design settings. In this regard, suitable adjustments may be implemented to counter less than optimal or nominal flow conditions.

Control assembly 22 may be comprised of any combination of analog and/or digital electronic control architecture now known or later developed. For example, control assembly 22 may be any conventional microprocessor, microcomputer, computer, or programmable logic device and may include a predetermined set of instructions, such as a computer program, in a memory portion. In one embodiment control assembly 22 includes a processor 23 configured for bidirectional electrical communication with various components of the fluid flow indicator system 18, and may be preprogrammed with fluid condition threshold ranges corresponding to the type of fluid dispensing nozzle used. The instructions allow fluid flow indicator system 18 to function in the manner described below in accordance with a predetermined set of criteria, rules and algorithms.

The performance parameters for flow conditions at given design pressures for the nozzle may be preprogrammed or remotely field programmable into control assembly 22 by a user. Example preprogrammed factory settings include, but are not limited to, for a design inlet pressure of 100 psi, extremely low flow condition occurs at an operating inlet pressure of 20 to 50 psi, low flow condition occurs at 50 to 75 psi, medium flow condition occurs at 75 to 100 psi, and nominal flow condition occurs at 100 psi or greater. Another set of example preprogrammed factory settings include, but are not limited to, for a design inlet pressure of 75 psi, extremely low flow condition occurs at an operating inlet pressure of 20 to 40 psi, low flow condition occurs at 40 to 50 psi, medium flow condition occurs at 50 to 75 psi, and nominal flow condition occurs at 75 psi or greater. Further details of several components of fluid flow indicator system 18 are provided below (also see FIG. 8 schematic).

Fluid flow indicator system 18 includes a power source 24, the power source preferably including one or more batteries configured to provide electrical power to the various elements of the fluid flow indicator system. Alternatively, the fluid flow indicator system 18 may use any suitable power source 24, including generating its own power. For example, the power source may include any harvesting energy technology such as using water flow and pressure as a prime mover to generate electrical energy and provide electrical power to the various components of the fluid flow indicator system 18. Other examples of harvesting energy technology also include, but are not limited to, piezo-electric materials. A contact spring 26 and one or more metal contacts or clips 28 establishes electrical connections between the power sources 24, and between the power sources 24 and control assembly 22.

Electrically non-conductive (e.g., plastic) covers or caps 30 may be provided to electrically insulate power sources 24 from adjacent elements such as a housing 32 (FIGS. 2, 3) for fluid flow indicator system 18. Housing 32 may include apertures 37 configured to receive caps 30 and sized to allow power sources 24 to be removed from fluid flow indicator system 18 for replacement.

Housing 32 includes an exterior facing portion configured to receive and enclose various control and power components, such as control assembly 22 and power sources 24. Housing 32 preferably includes one or more mounting posts 34 for retaining one or more of control assembly 22, cap 30, and contact spring 26. Housing 32 may further include compartments configured for receiving and partially enclosing power sources 24, and a port 35 configured for receiving a portion of sensor 20. Port 35 is also configured for providing fluid communication from fluid passage 15 to sensor 20 in order to sense the inlet operating fluid condition of pressure or flow rate. Housing 32 includes an interior facing portion configured to partially or fully surround and engage a portion of the nozzle shut-off body 10. In one embodiment, housing 32 includes a saddle portion 33 configured to partially or fully surround and engage a portion of the perimeter of the nozzle shut-off body 10.

In one embodiment, control assembly 22 includes one or more indicators 36, as at 36A, B, C, configured to provide the user with a visually or other sensory perceivable indication of the operating flow rate as compared to the rated design flow rate. The indicators 36 may be any suitable visually perceivable indicia, such as light emitting components, alpha-numeric readout, graphic readout, or other visual display. In one embodiment, as shown in FIGS. 3, 5, and 6, the indicators 36 are light emitting diodes (LEDs). The indicators 36 may be configured each to display a different color to correspond to predetermined operating fluid conditions. Alternatively, indicators 36 may include any suitable components that provide fluid condition indication to the user, such as by sound (e.g., audible alarms), or by feel (e.g., vibration). As shown in FIG. 8, control assembly 22 is in electrical communication with the indicators 36 via output signal 21. Control assembly 22 is configured to actuate a corresponding indicator for the determined level of fluid condition to allow a user of the fluid-dispensing nozzle assembly to perceive an indication of the level of the fluid condition. Preferably, indicators 36 are secured to the exterior facing portion of control assembly 22 and on the upper facing portion of the nozzle shut-off body 10, as to be easily perceived by the user. In one embodiment fluid flow indicator system 18 may be configured to display or indicate one or both of the operating fluid conditions, such as pressure or flow rate, by digital or other suitable display perceivable by the user.

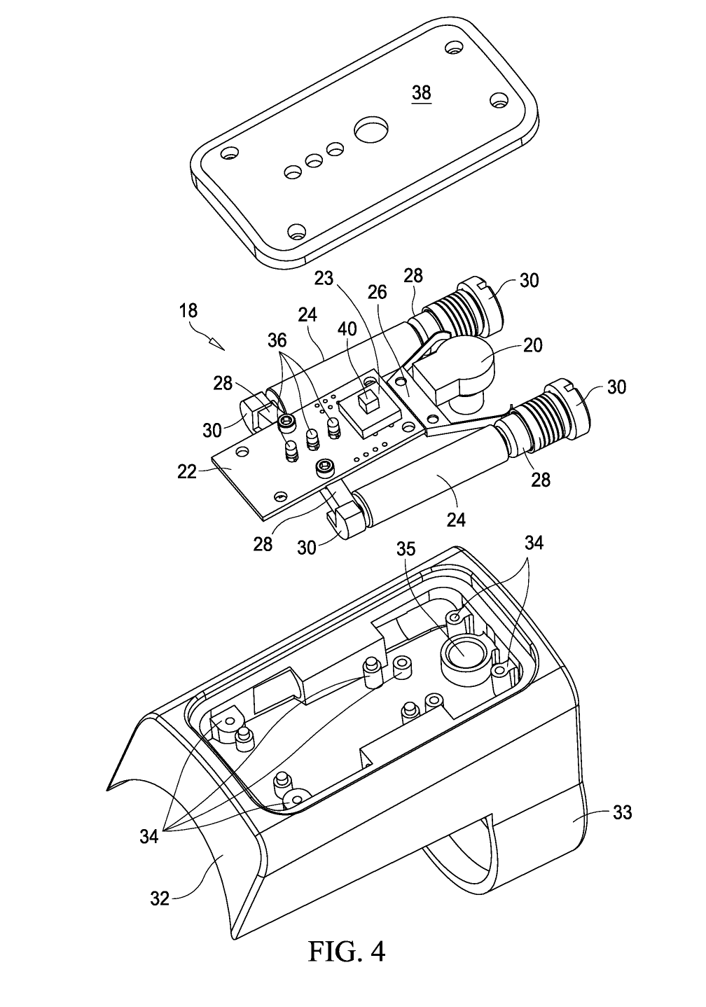

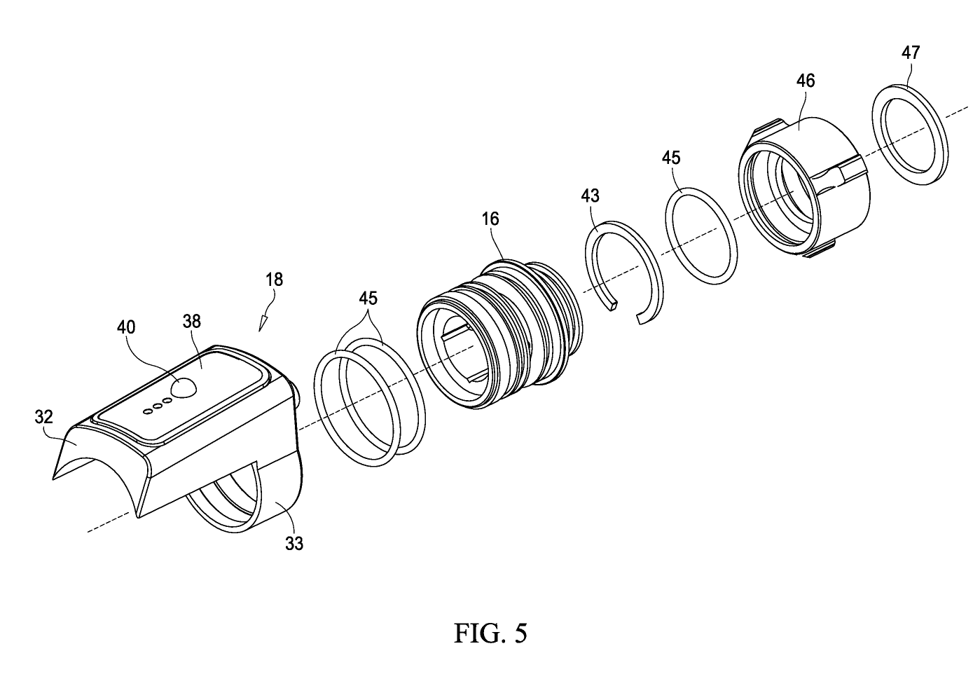

FIG. 4 shows top and bottom views respectively of a cover 38 that may be selectably attached to housing 32 with suitable fasteners, such as clips, screws or adhesive. Cover 38, when attached to housing 32, provides protection to the various components of fluid flow indicator system 18 from moisture, dust and debris and secures pressure sensor 20 in place. Housing 32 is configured for selectable removal and insertion of power sources 24 without removal of the cover 38. Cover 38 may further include openings or windows for indicators 34 and graphics and/or indicia corresponding to the various flow conditions. In one embodiment the graphics and/or indicia may be included on a removable decal overlay configured to attach to cover 38. The indicia may include, but are not limited to labels displaying “set pressure”, “caution”, and “low pressure”. The indicia may be located adjacent to corresponding indicators 36 to indicate corresponding different levels of fluid flow conditions.

In one embodiment, the cover 38 and/or the fluid flow indicator system 18 includes a user interface 40 configured for field or remote programming or adjustment of the display settings for the indicators 36. User interface 40 may be any suitable interface device such as a button or switch, or may include a USB or other suitable electronic connector or port. In one embodiment the remote programming of the indicator settings may be provided by any suitable user device such as a smart phone, tablet, or computer, and may be communicated to the fluid flow indicator system 18 by any suitable manner, such as by wired or wireless systems, or a combination thereof. As shown in FIG. 8, control assembly 22 is in electrical communication with the user interface 40. Preferably, user interface 40 is secured to the exterior facing portion of control assembly 22 and on the upper facing portion of the nozzle shut-off body 10, as to be easily accessed by the user.

The user interface 40 may be also be configured for troubleshooting or maintenance of the fluid flow indicator system 18. In one embodiment, control assembly 22 is configured for unidirectional or bidirectional electrical communication between user interface 40 and indicators 36 as shown schematically in FIG. 8. The user may activate and operate the user interface 40 in order to run diagnostic checks on the operation of the indicators 36, the power source 24, the sensor 20, and the software or programming of processor 23.

Fluid flow indicator system 18 may be configured operate with an automatic on/off control based on fluid pressure, and may revert to “sleep” mode when not in use. In an alternative embodiment, fluid flow indicator system 18 may include an On-Off power switch for controlling power supplied to fluid flow indicator system 18 by power source 24. Cover 38 may be sealed against housing 32 by an o-ring, gasket, sealant or any other material suitable for preventing water from entering the interior portions of the housing.

In one embodiment, during operation of fluid flow indicator system 18, control assembly 22 receives an electrical signal from sensor 20 corresponding to the measured pressure of fluid flowing through shut-off body 10. Processor 23 of control assembly 22 converts the sensor 20 output signal 21 into a corresponding operating fluid flow rate. For example, the fluid-dispensing nozzle assembly 42 may be rated to provide the optimal flow rate at 100 pounds per square inch (psi), but may be operating at a low flow condition due to an inlet supply pressure of only 60 psi. Based on the pre-set or user's setting of the pre-determined, or determinable pre-programmed criteria of control 22, RED, YELLOW and GREEN indicator 36A, 36B, 36C, respectively, LEDs may be illuminated individually or in a predetermined manner to indicate any desired flow condition. As a non-limiting example, for instance: flashing RED may indicate a dangerously insufficient fluid flow, continuously lit RED may indicate a low flow, continuously lit YELLOW may indicate a non-optimal flow, and continuously lit GREEN may indicate the rated flow or above.

Under the above example, when control assembly 22 determines a given operating condition such as low flow for a predetermined period of time, the RED indicator 36A would be continuously lit as long as the inlet pressure sensed is within the preset range, e.g., of about 50 to 75 psi. As the user perceives the low flow condition concurrently while operating the nozzle, they are able to communicate the flow condition back to the fire engine control center, where the engineer can adjust the engine supply pressure or other parameters to increase the pressure available at the nozzle inlet. As the pressure increases, the user obtains quick and easy feedback on the flow condition by watching the changing response of the indicators 36. Under the above example, once the inlet pressure is maintained in a range from about 75 to 100 psi, e.g., for a predetermined period of time, the control assembly 22 would cause YELLOW indicator 36B to be continuously lit to indicate a “caution” or medium flow condition. A further increase in pressure at the inlet maintained at 100 psi or greater, e.g., for a predetermined period of time would trigger control assembly 22 to cause GREEN indicator 36C to be continuously lit. This would quickly reassure the operator that nominal rated flow conditions at the nozzle have been met.

Referring to FIGS. 5-7, a fluid flow indicator system 18 with nozzle inlet adaptor 16 and further including an optional coupling 46 is shown. Nozzle inlet adaptor 16 and saddle 33 of housing 32 may be configured for sliding engagement or other suitable connection together or may be made integral. Nozzle inlet adaptor 16 may be sealed against saddle 33 of housing 32 by one or more o-rings 45. O-rings 45 may be any suitable sealer such as a gasket, sealant or any other material suitable for preventing water from entering the portions of the housing 32 containing electrical components. Nozzle inlet adaptor 16 may include an annular passage 56 configured to conduct fluid flow in the fluid passage 15 through the port 35 of housing 32 to the sensor 20. Nozzle inlet adaptor 16 may also include at least one opening 54, and the opening is configured to conduct fluid flow from fluid passage 15 to the annular passage 56. In one embodiment nozzle adaptor 16 includes four equally spaced openings 54 that conduct fluid from fluid passage 15.

Continuing reference to FIG. 7, in one embodiment a portion of the outlet end of nozzle inlet adaptor 16 may be configured to engage the inlet end of shut-off body 10. Nozzle inlet adaptor 16 and shut-off body 10 may be configured for sliding engagement or other suitable connection together or may be made integral. Coupling 46 may be configured for rotatable connection to a portion of the inlet end of nozzle inlet adaptor 16 at a first end of coupling 46 and may be configured for connection to a fluid supply line (not shown) at the second end of coupling 46. Coupling 46 may be rotatably connected to nozzle inlet adaptor 16 with piston ring 43 (see also FIG. 5) or other suitable connector. Coupling 46 may be sealed against nozzle inlet adaptor 16 by at least one o-ring 45 (see also FIG. 5) or other suitable sealing means. In an alternative embodiment, the inlet end of nozzle inlet adaptor 16 may be configured for connection to a monitor, such as, but not limited to a water monitor (not shown).

The general arrangement of a fluid flow indicator system 18 as part of a nozzle assembly 42 is shown in FIGS. 6 and 7 according to an embodiment of the present invention. Nozzle assembly 42 may be configured for connection to a fluid supply and for selectably controlling the discharge of fluids. Nozzle assembly 42 includes a discharge 44 configured for connection to the nozzle outlet 14 and may include coupling 46. Coupling 46 is configured for connection to a fluid supply line (such as a hose, for example, not shown), and coupling 46 is capable of providing rotation of the fluid supply line about its central longitudinal axis. Coupling 46 may be sealed against the fluid supply line with gasket 47 or other suitable sealer (FIGS. 5 and 7). In one embodiment the discharge 44 is configured for selectably controlling the discharge of fluids and may include dispensing fluid in an adjustable fluid spray pattern. For example, the spray pattern of fluids from discharge 44 may be adjustable from a generally narrowly-focused stream to a widely-diffused “fog.”

In one embodiment the nozzle assembly 42 includes a valve 48 disposed within and in fluid communication with the fluid passage 15 of nozzle shut-off body 10. The valve 48 may include a flow-controlling ball configured to provide an adjustable fluid flow through the nozzle assembly 42. In some embodiments a handle 50 is coupled to the valve 48 such that pivoting the handle causes the valve to move from a fully closed shut-off position to a fully wide-open flow position. In one embodiment the discharge 44 and/or the nozzle assembly 42 in general is configured for providing an adjustable fluid flow rate. For example, the discharge 44 may be adjusted to provide a 125, 150, 200 or 250 GPM flow rate. In some embodiments the nozzle assembly 42 may include a handgrip 52 connected to the nozzle shut-off body 10, the handgrip providing the user with increased stability and control of the nozzle.

The present invention may be utilized with any single, multi-flow or automatic flow nozzles within the scope of the invention, regardless of nozzle size. Likewise, the present invention may be utilized with any type of single, multi-flow or automatic flow nozzles that are operated manually or by any other means. In an alternative embodiment, the fluid flow indicator system 18 is integral with the fluid supply inlet of a monitor nozzle (not shown).

Thus, providing sensor 20 and the other components of fluid flow indicator system 18 integral with the nozzle assembly 42 provides the user with more accurate and immediate feedback on the flow operation of the nozzle in use, as compared to an in-line flow sensor and gauge-type indicator installed remotely further upstream in the line, out of the sight of the user. In one embodiment, fluid flow indicator system 18 includes a transmission system (shown schematically in FIG. 8) to transmit an output signal corresponding to the level of fluid condition to alternative or additional indicators 36 located remotely from the nozzle assembly 42. Additional indicators 36 may be located in any suitable remote location, such as with the user, on the user's uniform or helmet, or in the fire engine or other remote control center. Transmission of the output signal may be by any suitable wired or wireless system, without limitation, such as radio frequency (RF), visible light, infra-red light, Bluetooth®, sonic, or ultrasonic. In one embodiment the output signal may be received by a receiver (not shown) remotely located from the nozzle assembly 42. The receiver may include other devices such as a microcontroller, processor, or computer, and may be configured to provide a remote display or indication of the level of fluid condition. In one alternative embodiment, the output signal from sensor 20 may be transmitted by the fluid flow indicator system 18 to a remote receiver device with processor. The remote receiver device may be configured to display or indicate the fluid condition, such as pressure or flow rate, and/or the level of fluid condition based on predetermined, or determinable programmed fluid condition threshold ranges.

Any materials suitable for use with the environment and operating conditions expected for a fluid-dispensing nozzle may be utilized to fabricate any of the components of the present invention. In addition, any suitable manufacturing and assembly processes may be utilized, separately or in combination, to produce a fluid flow indicating system 18 within the scope of the present invention.

Although the present invention has been described in the context of dispensing fire-fighting fluids, and such fluids may include water and/or other chemicals, it will be understood that the present invention may be utilized to advantage in any application and any industry that uses single, multi-flow or automatic flow nozzles to dispense liquids and gases.

While this invention has been shown and described with respect to a detailed embodiment thereof, it will be understood by those skilled in the art that changes in form and detail thereof may be made without departing from the scope of the claims of the invention.

What is claimed is:

1. A fluid flow indicator system for fluid-dispensing nozzles, comprising:
a fluid passage having an inlet;
a sensor, the sensor being in communication with the fluid passage;
a control, the control being in electrical communication with the sensor;
a power source, the power source being in electrical communication with the sensor and the control; and
at least one indicator, the at least one indicator being in electrical communication with the control and actuable under at least one predetermined fluid condition;
whereby the sensor is configured to measure a fluid condition in the inlet of the fluid passage and to generate an output signal corresponding to the measured fluid condition; and
whereby the control is configured to process the output signal from the sensor, compare the output signal with predetermined fluid condition threshold ranges, each predetermined fluid condition threshold range representing a corresponding level of fluid condition, determine the corresponding level of fluid condition, and actuate the at least one indicator corresponding to the at least one predetermined fluid condition to allow a user of the fluid-dispensing nozzle to perceive an indication of the level of fluid condition.

2. The fluid flow indicator system of claim 1, further including a housing configured to receive the sensor, the control, the power source, and the at least one indicator.

3. The fluid flow indicator system of claim 2, further including:
a shut-off body having a nozzle inlet and a nozzle outlet,
the fluid passage being disposed within the shut-off body and being configured to conduct fluid flow from the nozzle inlet to the nozzle outlet.

4. The fluid-dispensing nozzle of claim 3 wherein the housing includes an interior facing portion configured to partially or fully surround and engage a portion of the shut-off body.

5. The fluid-dispensing nozzle of claim 3 wherein the housing includes a saddle portion configured to fully surround and engage a portion of the perimeter of the shut-off body.

6. The fluid-dispensing nozzle of claim 3, further including a nozzle inlet adapter configured to secure the housing to the shut-off body.

7. The fluid-dispensing nozzle of claim 1 wherein the at least one predetermined fluid condition is a low flow condition.

8. The fluid flow indicator system of claim 1 wherein the fluid condition relates to fluid flow.

9. The fluid flow indicator system of claim 1 wherein the fluid condition relates to fluid pressure.

10. The fluid flow indicator system of claim 1 wherein the sensor includes a pressure transducer.

11. The fluid flow indicator system of claim 1 wherein the control includes a printed circuit board.

12. The fluid flow indicator system of claim 1 wherein the power source includes at least one battery.

13. The fluid flow indicator system of claim 2 wherein the housing includes a removable cover and is configured for selectable removal and insertion of the power source while the cover is attached.

14. The fluid flow indicator system of claim 1, further including at least three indicators, and each indicator corresponding to a predetermined level of fluid condition.

15. The fluid flow indicator system of claim 1 wherein the at least one indicator is a light emitting diode.

16. A fluid flow indicator system for fluid-dispensing nozzles, comprising:
a shut-off body having a nozzle inlet and a nozzle outlet, a fluid passage being disposed within the shut-off body and being configured to conduct fluid flow from the nozzle inlet to the nozzle outlet;
a discharge connected to the nozzle outlet of the shut-off body, the discharge configured for dispensing fluid in a spray pattern;
a sensor, the sensor being in communication with the fluid passage;
a nozzle inlet adapter, the nozzle inlet adapter configured to conduct fluid flow from the fluid passage to the sensor;
a control, the control being in electrical communication with the sensor;
a power source, the power source being in electrical communication with the sensor and the control; and
at least one indicator, the at least one indicator being in electrical communication with the control and actuable under at least one predetermined fluid condition;
whereby the sensor is configured to measure a fluid condition in the inlet of the fluid passage and to generate an output signal corresponding to the measured fluid condition; and
whereby the control is configured to process the output signal from the sensor, compare the output signal with predetermined fluid condition threshold ranges, each predetermined fluid condition threshold range representing a corresponding level of fluid condition, determine the corresponding level of fluid condition, and actuate the at least one indicator corresponding to the at least one predetermined fluid condition to allow a user of the fluid-dispensing nozzle to perceive an indication of the level of fluid condition.

17. The fluid flow indicator system of claim 16, further including a user interface in electrical communication with the control and the sensor.

18. The fluid flow indicator system of claim 16, further including a shut-off flow control in fluid communication with the fluid passage.

19. The fluid flow indicator system of claim 16 wherein the control is configured to actuate the at least one indicator to indicate a low flow fluid condition.

20. A method of indicating fluid condition for fluid-dispensing nozzles, comprising:
providing a fluid flow indicator system in the fluid-dispensing nozzle, the fluid flow indicator system including:
a fluid passage having an inlet;
a sensor, the sensor being in communication with the fluid passage;
a control, the control being in electrical communication with the sensor;
a power source, the power source being in electrical communication with the sensor and the control; and
at least one indicator, the at least one indicator being in electrical communication with the control and actuable under at least one predetermined fluid condition;
measuring a fluid condition in the inlet of the fluid passage with the sensor;
generating an output signal with the sensor corresponding to the measured fluid condition;
processing the output signal from the sensor with the control;
comparing the output signal with predetermined fluid condition threshold ranges, each predetermined fluid condition threshold range representing a corresponding level of fluid condition;
determining the corresponding level of fluid condition; and
actuating the at least one indicator corresponding to the determined level to allow a user of the fluid-dispensing nozzles to perceive an indication of the level of fluid condition.
